(19) United States
(12) Patent Application Publication
(10) Pub. No.: US 2024/0361542 A1
(43) Pub. Date: Oct. 31, 2024

(54) OPTICAL DEVICE AND METHOD FOR PRODUCING AN OPTICAL DEVICE

(71) Applicant: JENOPTIK Optical Systems GmbH, Jena (DE)

(72) Inventors: Christian KARRAS, Jena (DE); Thomas KADEN, Jena (DE); Tobias GNAUSCH, Jena (DE); Robert BUETTNER, Jena (DE); Armin GRUNDMANN, Jena (DE)

(73) Assignee: JENOPTIK Optical Systems GmbH, Jena (DE)

(21) Appl. No.: 18/291,295

(22) PCT Filed: Jul. 13, 2022
(86) PCT No.: PCT/EP2022/069640

§ 371 Date: Jan. 23, 2024

(30) Foreign Application Priority Data
Jul. 23, 2021 (DE) 10 2021 119 192.0

(51) Int. Cl. G02B 6/42

(52) U.S. Cl. CPC G02B 6/4214

(57) ABSTRACT

An optical module for modifying a light beam, wherein the optical module is made of a single-piece solid body material and has a passage surface for receiving the light beam. Furthermore, the optical module comprises a beam deflecting region lying opposite the passage surface for deflecting the light beam, wherein the beam deflecting region is designed as a curved region on the exterior of the optical module, in particular so as to have a hollow mirror function, a pass-through surface for outputting the light beam deflected by the beam deflecting region and a beam shaping region that is designed to shape the light beam and additionally or alternatively thereto the deflected light beam such that the light beam has a beam profile a with homogeneous intensity distribution over a specified range.

The present approach relates to an optical device and a method for producing an optical device.

The invention relates to an optical module for a method with which the functionality of electrical and optical components or circuits of a chip can be tested simultaneously at wafer level in a wafer prober. A method of this type is known from US 2011/0279812 A1.

The invention is in the field of testing and qualifying chips with optical-electrical integrated circuits, so-called PICs (photonic integrated circuits), at the wafer level. In contrast to conventional, purely electrically integrated circuits, so-called ICs (integrated circuits), PICs also integrate optical functionalities in addition to the electrical circuits.

### PRIOR ART

The testing of PICs at the wafer level requires the coupling of light into and out of the plane of the PICs, usually by means of integrated grating couplers as coupling points, as described in the technical paper titled “Grating Couplers for Coupling between Optical Fibers and Nanophotonic Waveguides” (D. Taillaert et al, Japanese Journal of Applied Phys[i]cs, Vol. 45, no. 8A, 2006, pp. 6071-6077). The grating couplers can be a functional component in the chip or sacrificial structures on the wafer, for example in the scribe line or on neighboring chips.

According to the prior art, glass fiber-based systems are used for wafer-level testing, as described in the technical paper titled: “Test-station for flexible semi-automatic wafer-level silicon photonics testing” (J. De Coster et al., 21th IEEE European Test Symposium, ETS 2016, Amsterdam, Netherlands, May 23-27, 2016. IEEE 2016, ISBN 978-1-4673-9659-2). These contain a glass fiber-based optical module that couples light into and out of the chip's coupling points via individual glass fibers. To ensure repeatable optical coupling, the glass fibers must be aligned with sub-micrometer precision to the coupling points at a distance of up to a few micrometers. This is only possible with the aid of high-precision actuators, for example in combination with hexapods and piezo elements. Secondly, each individual optical coupling must be preceded by a time-consuming, active adjustment process designed to achieve maximum coupling efficiency. The test equipment required for the wafer level test is available in the form of wafer probers and wafer testers with associated contacting modules (also known as probe cards). By means of contacting module, the device-side interfaces of the wafer tester are connected to the individual interfaces of the chips of the wafer fixed on the wafer prober.

The ultra-fast optoelectronic probe card is a test solution in the form of an optoelectronic probe card that can be used for wafer level testing in the volume production of photonic integrated circuits (PICs), for example. A key feature is so-called plug & play capability with existing wafer level test equipment and wafer probers, which can be used in the volume production of conventional ICs (integrated circuits). WO002019029765A9 is listed in this connection as a separate beam shaping element for shaping a top hat profile. The disadvantage is the use of a separate element for beam shaping.

US 2006/0109015 A1 describes an optoelectronic contacting module (probe module) for testing chips (for object under test—DUT 140) with electrical and optical inputs and outputs. If, as described in US 2006/0109015 A1, the coupling efficiency of the optical signal is optimized by collimating or focusing the optical beam, the entire contacting module must be adjusted with high precision in the sub-μm range. Otherwise, the adjustment-dependent repeatability of the measurement is not sufficient for the applications described. This in turn means that the contacting module cannot utilize the adjustment tolerances for electrical contacting in the range of a few micrometers in the X, Y and Z directions that are typical in conventional electrical wafer probers.

US 2011/0279812 A1 discloses a contacting module for testing chips with electrical and optical inputs and outputs. The chip is mounted on a movable carrier with which it can be roughly aligned with the contacting module. The rough alignment is effected on a sensor-controlled basis using position monitoring of the chip or the adjustment marks on the chip. This is complicated and prone to faults.

US 2018/0142855 A1 discloses a light beam adjustment device for a vehicle lamp in which a deflector element is formed as the curved outer surface of a monolithic light guide body.

CN112578572 A discloses a light funnel designed as a solid body with a curved reflective surface.

DE102010063938 A1 discloses an optical system for laser beam shaping with a cone-shaped reflective surface.

### DISCLOSURE OF THE INVENTION

Against this background, the present approach presents an optical device with an optical module for modifying a light beam and a method for producing the optical device according to the main claims. Advantageous embodiments result from the respective dependent claims and the following description.

With the invention presented here, insufficient positioning accuracy of conventional wafer probers for reproducible optical coupling can advantageously be compensated for by a suitable optical coupling principle that is insensitive to positional tolerances.

An optical module for modifying a light beam is presented, wherein the optical module is made of a single-piece solid body material and has a pass-through surface for receiving the light beam. The pass-through surface can be provided as a light-entry surface (also referred to as a light-receiving surface). Furthermore, the optical module comprises a beam deflecting region lying opposite the pass-through surface for deflecting the light beam, wherein the beam deflecting region is designed as a curved region on the exterior of the optical module, in particular so as to have a hollow mirror function, a pass-through surface that can be provided for outputting the light beam deflected by the beam deflecting region, i.e., as a light exit surface, and a beam shaping region that is designed to shape the light beam and additionally or alternatively the deflected light beam such that the light beam has a beam profile with a homogeneous intensity distribution over a specified range. For example, the optical module can be formed of a glass substrate and can be used, for example, as part of an optical device for measuring wafers. The light beam can initially be directed through the pass-through surface to the beam deflecting region in order to convert the light beam into the deflected light beam and forward it in the direction of the pass-through surface. The beam deflecting region can be curved in a similar way to a hollow mirror and can therefore also be referred to as a hollow mirror or mirror. A collimated beam profile can be advantageously generated by the curvature. A collimated beam profile, i.e., a beam profile that has a constant beam diameter along the beam propagation direction, can be highly advantageous for the position tolerance sensitivity of the coupling into an object under test (also referred to as a test object; in English, “device under test,” abbreviated as “DUT”), in particular in the Z direction. For example, manufacturing-related tolerance influences from height differences on the wafer or the wafer prober chuck (non-optimal adjustment and plane parallelism to the headplate) can be compensated for. It can also enable the ability to vary the optical working distance, without thereby changing the optical coupling properties. This can, for example, enable the use of different overdrives for simultaneous electrical contacting with needles. In addition to the curved beam deflecting region, the optical module comprises the beam shaping region, which can also be referred to as the beam shaping element. When the deflected light beam exits from the pass-through surface, the deflected light beam is already modified by the beam shaping region and has a beam profile with a homogeneous intensity distribution. For example, the beam profile can be collimated on the one hand. In addition, the deflected light beam can be shaped with a so-called top-hat beam profile in order to evenly illuminate a specified region of an object under test, for example a third or a quarter of the illuminated surface. Due to the single-piece design of the optical module, a highly reproducible and highly precise positioning of the beam shaping element to the beam path can be achieved, usually better than 1% of the beam diameter, along with a highly reproducible mirror angle (0.1° deviation at 8.0° target angle can generate an approximately 0.2 μm offset at a 100 μm distance of the beam deflecting region to the BSE). Thus, the optical module advantageously enables the simultaneous generation of a collimated beam and a top-hat beam profile, wherein the described combination of optical elements can advantageously minimize the influence of various tolerances on the beam shaping.

According to one embodiment, the beam deflecting region and the beam shaping region can be arranged on overlapping sections of the exterior. For example, a region of the exterior can be both curved and thus fulfill the function of a hollow mirror, as well as have the beam shaping region in order to convert the light beam into a beam profile with a homogeneous intensity distribution, for example a top-hat beam profile, during deflection. Advantageously, this embodiment eliminates manufacturing-related position tolerances, which would otherwise occur if the mirror and beam shaping element were designed separately. It also enables a highly compact design of the beam path.

The beam deflecting region can be designed to be rotationally symmetrical. The axis of symmetry can be provided as a bisector between the optical axes or the respective central beam of the incident and outgoing beam bundles at the beam deflecting region. An optical axis can be understood as an axis that a light beam can take when passing through the optical system. An optical axis can also form a central beam of the light beam (i.e., a middle or central beam of a light beam bundle) that runs through an optical system. For example, the optical axis can run through a rotationally symmetrical beam section in the form of an axis of symmetry.

According to a further embodiment, the pass-through surface can be formed by the beam shaping region. For example, the collimating hollow mirror and beam shaping element can be spatially separate elements within the optical module. The beam shaping region can be designed as part of the pass-through surface, for example, in order to shape the light beam deflected by the beam deflecting region into a top hat profile, for example, as it exits the optical module. Advantageously, through such an arrangement, each element can be optimized separately.

According to a further embodiment, the beam shaping region can be formed with at least two turning points for shaping the light beam and additionally or alternatively the deflected light beam. A turning point can be characterized by the fact that the curvature of the beam shaping region changes its sign at such point. For example, the beam shaper can be designed with a wave-like profile to advantageously enable an optimum homogeneous intensity distribution, for example to generate a top-hat beam profile. The two turning points can be defined in a sectional plane that contains the optical axis or the central beam of the light beam and that of the deflected light beam. The turning points can in each case represent a transition from a convex to a concave sub-section of the beam shaping region in the sectional plane. When viewed in three dimensions, at least one turning line can be present. The turning line can be an oval or, in special cases, a circular, closed curve that intersects the sectional plane at the two turning points. The turning line can represent a boundary between a convex sub-region of the beam shaping region and a concave sub-region of the beam shaping region.

According to a further embodiment, the beam shaping region can be free of turning points, i.e., without the curvature changing its sign. In this case, the beam shaping region can particularly advantageously have at least two turning points in the first derivative of the optical surface for shaping the light beam and additionally or alternatively the deflected light beam. A turning point of the first derivative of the optical surface can be visualized by the fact that the first derivative of the curvature changes its sign at this point.

The beam deflecting region can be designed to deflect the light beam at a deflection angle of 90°. The deflection angle can be considered as the angle between the central beams of the incident and outgoing beam bundles. The beam bundles in the solid body material can be used for this purpose. The beam exiting from the solid body material can have a different direction due to diffraction if it strikes the pass-through surface at an angle deviating from the perpendicular. According to a further embodiment, the beam deflecting region can be designed to convert the light beam into the deflected light beam by total internal reflection. Additionally or alternatively, the beam deflecting region can be designed to deflect the light beam at an obtuse angle, i.e., a deflection angle of more than 90° degrees, in order to obtain the deflected light beam. The deflection angle can advantageously be between 94° and 110°, particularly advantageously between 96° and 100°. Advantageously, the deflected beam can strike at an angle of 6° to 10° to the normal of the pass-through surface. The angle of the deflected central beam beyond the pass-through surface, i.e., in the free beam region, can then be 10° to 14°. Such angle of the free beam can correspond to the intended angle of the coupling point of the test object (DUT). The coupling point can be designed as a grating coupler, for example. The grating coupler can have a design angle of 12°, for example, which deviates from the perpendicular. For example, the exterior of the optical module in the beam deflecting region can be designed as a thin layer of the glass substrate, which can generate total internal reflection at the interface between glass and air. Additionally or alternatively, the beam deflecting region can also be formed with a curvature that can bundle the light beam around the deflection angle simultaneously with the deflection. Advantageously, this can lead to the conversion of the light beam into the deflected light beam with minimal losses.

According to a further embodiment, the beam deflecting region can be formed with a layer reflecting the light beam in order to obtain the deflected light beam. For example, the beam deflecting region on the side of the light beam can be coated with a layer of metal in order to reflect light and thus redirect the light beam. Advantageously, such a reflective layer can be produced cost-effectively.

In addition, an optical device is presented which comprises at least one variant of the optical module presented above and a waveguide for guiding the light beam to the passage surface of the optical module. For example, the optical device can be used to perform a wafer level test after completion of a wafer. Using the optical module, the optical device enables a collimated beam profile, i.e., a beam profile that has a constant beam diameter along the beam propagation direction and contributes to a homogenization of the angular distribution in order to generate the position tolerance insensitivity of the coupling into the DUT. At the same time, it is advantageously possible to generate a top-hat beam profile with the optical device presented here. By appropriately combining the beam shaping elements, the influence of different tolerances on the beam shaping can also be minimized and thus the desired optical functions can be made possible in the first place under the installation space conditions of, for example, an optoelectronic probe card.

According to the invention, the optical device and the optical module are formed in a single piece from a solid body material. For example, the device and the optical module can be made from a glass substrate, for example using a laser method. Advantageously, the optical device can thus be produced compactly and cost-effectively.

According to a further embodiment, the beam deflecting region can be formed as part of a blind hole in the solid body material. For example, an exterior of the optical device in the region of the beam deflecting region can be ablated down to a thin layer by the blind hole, in order to advantageously enable a total internal reflection of the light beam in the beam deflecting region.

According to a further embodiment, the optical device can comprise at least one further variant of the optical module presented above. For example, the optical device can have any number of optical modules, which can be arranged in a row, for example, in order to test a plurality of wafers in one test run.

In addition, a method for producing a variant of the optical module presented above is presented, wherein the method comprises a step of providing the solid body material, along with a step of inscribing the contour of the beam deflecting region into the solid body material and a step of exposing the beam shaping region, in particular by selectively removing the solid body material described by the step of inscribing. For example, a laser direct writing method can be used in order to write the desired contour into a glass substrate. For example, if the optical module is part of an optical device and is formed in a single piece, the contour of the hollow mirror with a modified surface shape and/or the waveguide can be inscribed in one manufacturing step. Subsequently, the hollow mirror can be shaped, for example, by selective etching, for example with hydrofluoric acid or KOH (potassium hydroxide solution) or by dry etching, and then advantageously polished with a CO2 laser. The waveguide terminates at a specified distance in front of the mirror. For example, the light can then also propagate divergently from the waveguide end to the beam deflecting region in the glass body (glass substrate).

The waveguide does not quite reach the beam deflecting region. This can result in divergent light propagation from the waveguide end to the deflecting region, for example, so that the deflecting region is illuminated as well as possible. The position of the waveguide end can be determined accordingly. The light propagation in the optical module, i.e., in the beam path between the passage surface and the pass-through surface, can also take place entirely in the solid body material so that, for example, the light propagation is free of free beam regions in which the light passes through air or another gas or an airless space. However, in the beam path after the deflecting region, the light can also pass through a free beam region after the pass-through surface, for example. The pass-through surface can represent an optical interface between the solid body material and air. The pass-through surface can be provided as a light exit surface. If the pass-through surface is intended for light exit, this can be referred to as an actuator application. After such a pass-through surface, an oblique light exit can also take place, which can be directed onto an object, such as a wafer with one or more test objects (DUT) arranged on it. An oblique light exit is understood to mean that a central beam of the exiting light strikes the wafer surface at an angle deviating from the perpendicular.

The light propagation in the optical device, which comprises the optical module and the waveguide, can also take place entirely in the solid body material, so that, for example, the light propagation in the optical device is free of free beam regions. In such an optical device, the passage surface can be understood as an imaginary surface located in the solid body material, which surface comprises the waveguide end. The waveguide end can be understood as an optical interface between the solid body material and the waveguide formed from modified solid body material. The modified solid body material can be produced as described below by inscribing the waveguide into the solid body material. The modified solid body material can have a higher refractive index than the solid body material. The passage surface can be defined perpendicular to the central beam of light at the end of the waveguide.

Advantageously, the beam deflecting region for deflecting the light beam can have a deflection angle of between 70° and 120°, particularly advantageously between 95° and 110°. Thus, the deflection angle between the incident light beam and the light beam deflected at the beam deflecting region can advantageously be between 70° and 120°, particularly advantageously between 95° and 110°. An optimal coupling to the respective object under test (DUT) can then be effected. The deflection angle between the incident light beam and the deflected light beam can be determined with respect to the respective central beam, which can represent the main direction of propagation of the incident or outgoing light.

In the case of a sensory application, the light can also enter the module through the pass-through surface according to a reciprocity or in accordance with a beam reversal problem and be deflected in the direction of the waveguide in the deflecting region. In this application, the “pass-through surface” can serve as a “light beam receiving surface” instead of an “exit surface.” Thus, the pass-through surface can be provided for receiving the light beam and the passage surface for outputting the light beam deflected by the beam deflecting region. In this case, the optical module can also have a beam deflecting region lying opposite the passage surface for deflecting the light beam, wherein the beam deflecting region is designed as a curved region on the exterior of the optical module, in particular so as to have a hollow mirror function, along with a beam shaping region that is designed to shape the light beam such that the light beam has a beam profile with a homogeneous intensity distribution over a specified range. In this case, the waveguide, which is provided for guiding the light beam from the passage surface of the optical module, can terminate at a distance from the beam deflecting region. In particular, the optical device can be designed to allow the light to propagate convergently from the beam deflecting region to one end of the waveguide; this end of the waveguide can form the passage surface.

The optical module or optical device can be designed for either actuator or sensor applications. The optical module or the optical device can also be provided simultaneously or selectably for actuator and sensor applications. The actuator application can comprise illuminating a test object (DUT) with the light beam shaped by the optical module. The sensory application can comprise the detection of a light beam emerging by the test object (DUT) or reflected by the test object (DUT) and shaped by the optical module.

This method can be implemented, for example, in software or hardware or in a mixed form made up of software and hardware, for example in a control device.

The approach presented here also creates a control device that is designed to carry out, control, or realize the steps of a variant of a method presented here in corresponding setups. The object forming the basis of the invention can also be achieved quickly and efficiently by this embodiment variant of the invention in the form of a control device.

For this purpose, the control device can have at least one computing unit for processing signals or data; at least one memory unit for storing signals or data; at least one interface to a sensor or an actuator for reading in sensor signals from the sensor, or for outputting control signals to the actuator; and/or at least one communication interface for reading in or outputting data which are embedded in a communication protocol. The computing unit can, for example, be a signal processor, a microcontroller, or the like, wherein the memory unit can be a flash memory, an EEPROM, or a magnetic memory unit. The communication interface can be designed to read or output data wirelessly and/or in a line-bound manner, wherein a communication interface that can read or output line-bound data can, for example, read these data electrically or optically from a corresponding data transmission line or output them into a corresponding data transmission line.

In the present instance, a control device can be understood to mean an electrical device that processes sensor signals and, depending thereon, outputs control and/or data signals. The control device may have an interface which may be designed as hardware and/or software. In a hardware embodiment, the interfaces can, for example, be part of what is known as a system ASIC, which includes a wide variety of the functions of the control device. However, it is also possible for the interfaces to be separate integrated circuits or at least partially consist of discrete components. In a software design, the interfaces may be software modules which, for example, are present on a microcontroller in addition to other software modules.

Exemplary embodiments of the approach presented here are shown in the drawings and explained in more detail in the following description. In the figures:

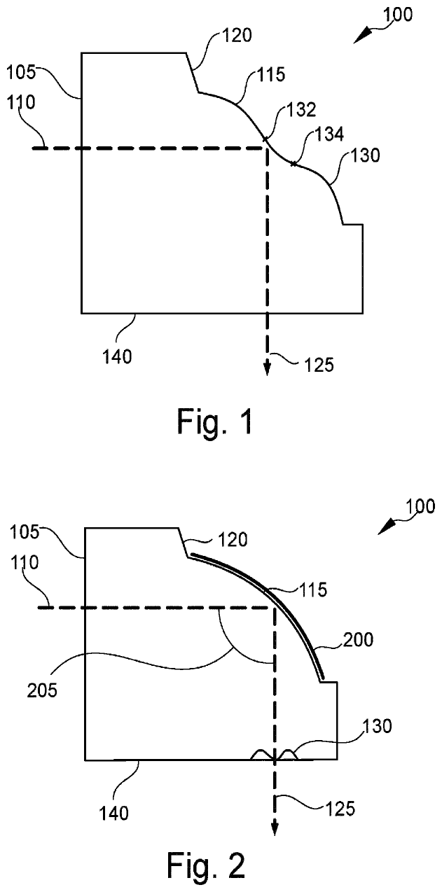

FIG. 1 shows a schematic cross-sectional representation of an optical module according to an exemplary embodiment;

FIG. 2 shows a schematic cross-sectional representation of an optical module according to an exemplary embodiment;

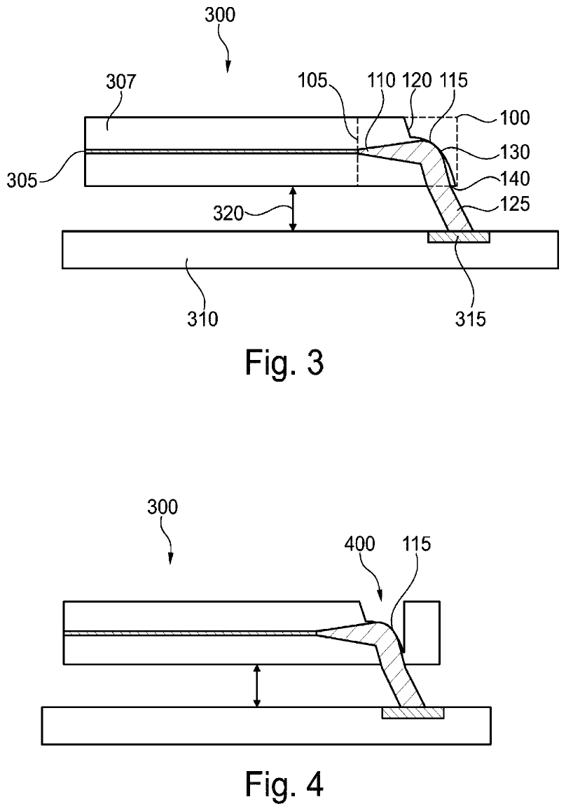

FIG. 3 shows a schematic representation of an optical device according to one embodiment;

FIG. 4 shows a schematic representation of an optical device according to one embodiment;

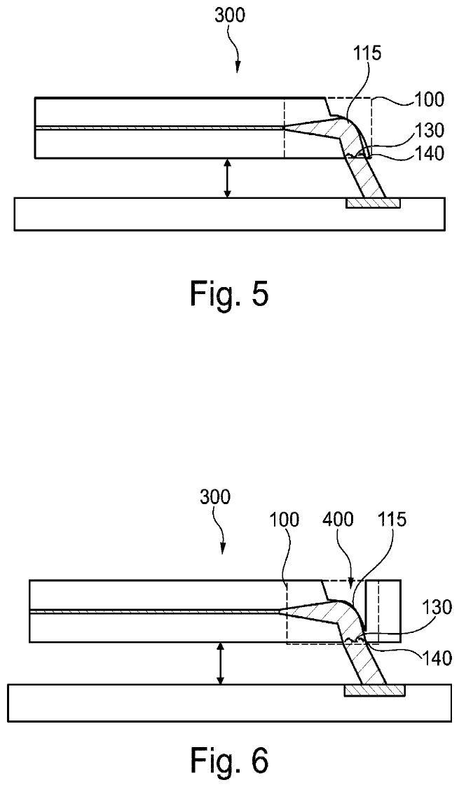

FIG. 5 shows a schematic representation of an optical device according to one embodiment;

FIG. 6 shows a schematic representation of an optical device according to one embodiment;

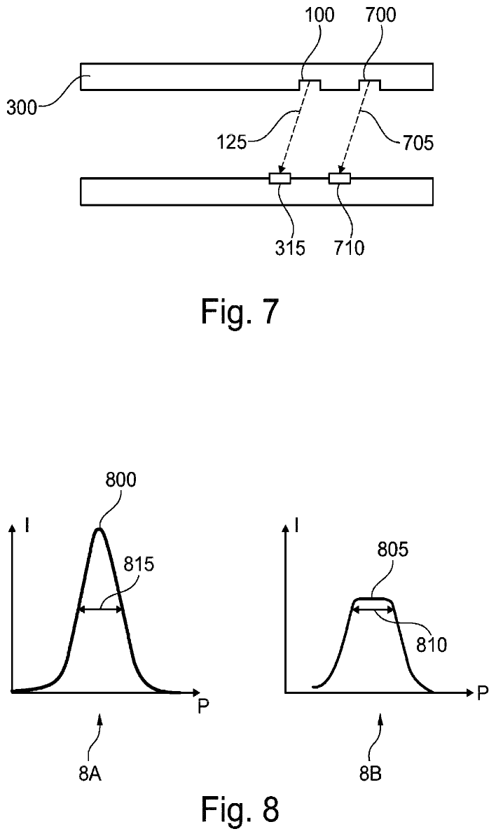

FIG. 7 shows schematic representation of an exemplary embodiment of an optical device with a further optical module;

FIG. 8 shows two diagrams comparing a Gaussian beam profile with a top-hat beam profile;

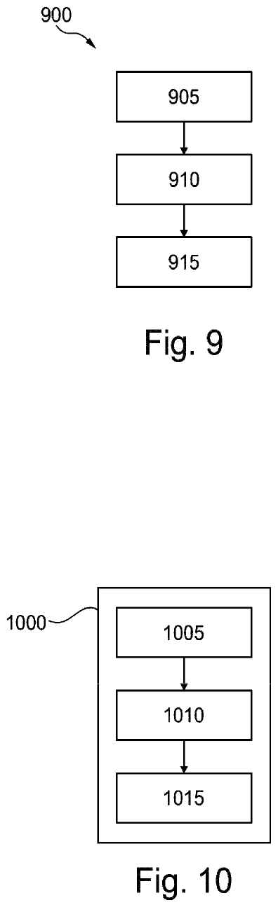

FIG. 9 shows a flow chart of a method for producing an optical module according to an exemplary embodiment; and

FIG. 10 shows a block diagram of an exemplary embodiment of a control device for controlling a method for producing an optical module according to a variant presented here.

In the following description of advantageous exemplary embodiments of the present invention, the same or similar reference characters are used for the elements that are shown in various figures and having a similar effect, wherein a repeated description of these elements is dispensed with.

FIG. 1 shows a schematic cross-sectional representation of an optical module 100 according to an exemplary embodiment. The optical module 100 is made of a single-piece solid body material, which is a glass substrate only by way of example, and has a passage surface 105 for receiving a light beam 110. A beam deflecting region 115 is formed opposite the passage surface 105, which beam deflecting region is designed to deflect the light beam 110 received via the passage surface 105. For this purpose, the beam deflecting region 115 is designed as a curved region on the exterior 120 of the optical module 100 and with a hollow mirror function. In this exemplary embodiment, the beam deflecting region 115 is designed to deflect the light beam 110 by total internal reflection and convert it into a collimated deflected light beam 125. The optical module 100 is also designed with a beam shaping region 130 in order to shape the light beam 110 such that the light beam has a beam profile with a homogeneous intensity distribution. By way of example only, in the exemplary embodiment shown here, the beam shaping region 130 is arranged on a section of the exterior 120 that overlaps with the section in which the beam deflecting region 115 is arranged. In other words, the exterior 120 of the optical module 100 has a curved region that is formed as both a beam deflecting region 115 and a beam shaping region 130. In this exemplary embodiment, the beam shaping region 130 is formed with a first turning point 132 and a second turning point 134 in order to shape the light beam 110 into a top-hat beam profile. Thus, this representation is a principle sketch of a modification to the surface of the hollow mirror in order to implement a beam shaping function. Various beam shapes can optionally be carried out; a top hat beam profile is advantageous. The exact geometry of the surface is determined by design and simulation under the respectively specific optical boundary conditions of the optical module as part of an overall optical device and depends, among other things, on the waveguide beam profile, the distance of the waveguide to the mirror, the wavelength, the refractive index of the substrate material, etc. The light beam 110 shaped by the beam shaping region 130 can be directed as a deflected light beam 125 to a pass-through surface 140, which is designed to output the deflected light beam 125.

FIG. 2 shows a schematic cross-sectional representation of an optical module 100 according to an exemplary embodiment. The optical module 100 shown here corresponds to or is similar to the optical module described in the preceding figure, with the difference that the beam shaping region 130 is arranged separately from the beam deflecting region 115. As described in the preceding figure, the optical module 100 is also designed in this exemplary embodiment to receive a light beam 110 via a passage surface 105 and to lead it to the beam deflecting region 115 lying opposite the passage surface 105. The beam deflecting region 115 is formed as a curved region on the exterior 120 of the optical module 100. In contrast to the exemplary embodiment described in the preceding figure, the beam deflecting region 115 in this exemplary embodiment is formed with a uniform curvature without turning points. In this exemplary embodiment, the beam deflecting region 115 is formed only by way of example with a layer 200 reflecting the light beam 110, which is a metal layer only by way of example. In this exemplary embodiment, the beam deflecting region 115 is shaped to deflect the light beam 110 at an angle 205 of 90° degrees, only by way of example, in order to obtain the deflected light beam 125. In other exemplary embodiments, the angle can vary depending on the intended use of the optical module, but the angle can advantageously be an obtuse angle, i.e., greater than 90°. In this exemplary embodiment, the light beam 110 is deflected by the beam deflecting region 115 at the described angle 205 in the direction of the pass-through surface 140. In this exemplary embodiment, the pass-through surface 140 is formed by the beam shaping region 130. The beam shaping region 130 is designed to shape the deflected light beam 125 such that the light beam has a beam profile with a homogeneous intensity distribution over a specified range.

FIG. 3 shows a schematic representation of an optical device 300 according to one embodiment. The optical device 300 comprises an optical module 100 corresponding or similar to the optical module described in the preceding figures, and a waveguide 305 for guiding the light beam 110 to the passage surface 105 of the optical module 100. In this exemplary embodiment, the optical device 300 and the optical module 100 are formed in a single piece from a solid body material 307, which is a glass substrate only by way of example. In this exemplary embodiment, the waveguide 305 is formed with single-mode fibers in order to guide the light beam 110 to the optical module 100 in an approximately normally distributed manner in a radial direction, only by way of example. Within the optical module 100, the light beam 110 can be deflected by means of the beam deflecting region 115 and converted into a collimated deflected light beam 125 by means of the beam shaping region 130, wherein the deflected light beam 125 in this exemplary embodiment has an intensity profile with a homogeneous beam distribution, since the beam shaping region 130 and the beam deflecting region 115 in this exemplary embodiment are arranged at overlapping sections of the exterior 120 of the optical module 100. Via the pass-through surface 140, the deflected light beam 125 in this exemplary embodiment can be aligned with a top-hat beam profile to an object under test 310 (DUT). The top hat has a homogeneous intensity distribution over a specified range of a surface 315 to be illuminated. By way of example only, the specified range is approximately one third of the surface 315 to be illuminated. The surface 315 to be illuminated can also be referred to as a grating coupler. By means of an obtuse deflection angle, the illumination of the surface to be illuminated is achieved at an angle that deviates from the perpendicular. This angle can be 12° only by way of example. For this purpose, a deflection angle of 7° to 9° is provided, which leads to the desired illumination angle due to the refraction of light on the pass-through surface 140. By forming the optical module 100 with the beam shaping region 130 in the same section as the beam deflection region 115, a working distance 320 between the optical device 300 and the object 310 under test can be varied, without requiring readjustment of a distance and additionally or alternatively an angle between the beam deflecting region 115 and the beam shaping region 130.

FIG. 4 shows a schematic representation of an optical device 300 according to one embodiment. The optical device 300 shown here corresponds to or is similar to the optical device described in the preceding FIG. 3, with the difference that, in this exemplary embodiment, the beam deflecting region 115 is formed as part of a blind hole 400 in the solid body material.

FIG. 5 shows a schematic representation of an optical device according to one embodiment. The optical device 300 shown here corresponds to or is similar to the optical device described in the preceding FIGS. 3 and 4, with the difference that the pass-through surface 140 of the optical module 100 is formed by the beam shaping region 130. As a result, the beam shaping region 130 can be optimized independently of the beam deflecting region 115.

FIG. 6 shows a schematic representation of an optical device 300 according to one embodiment. The optical device 300 shown here corresponds to or is similar to the optical device described in the preceding FIGS. 3, 4 and 5. In this exemplary embodiment, the beam deflecting region 115 is formed as part of a blind hole 400 in the solid body material of the device 300 and the pass-through surface 140 of the optical module 100 is formed by the beam shaping region 130.

FIG. 7 shows a schematic representation of an exemplary embodiment of an optical device 300 with a further optical module 700. The optical device 300 shown here corresponds to or is similar to the optical device described in the preceding FIGS. 3, 4, 5, and 6, with the difference that the device 300 shown here comprises a further optical module 700 in addition to the optical module 100. The other optical module 700 is designed to be congruent with the optical module 100. Both optical modules 100, 700 are designed to generate a deflected light beam 125 and a further deflected light beam 705 with a beam profile with a homogeneous intensity distribution over a specified range of a surface 315 to be illuminated and a further surface 710 to be illuminated. In a further exemplary embodiment, the optical device can comprise a plurality of additional optical modules, all of which can be designed to be similar or identical to the optical module described in the preceding FIGS. 1 and 2.

FIG. 8 shows two diagrams 8A and 8B for comparing a Gaussian beam profile 800 with a top-hat beam profile 805, wherein the position P is plotted on the abscissa and the intensity I is plotted on the ordinate. Compared to the Gaussian beam profile 800, the top-hat beam profile 805 has an almost rectangular profile along with a homogeneous intensity distribution within the entire beam diameter 810. On the other hand, the Gaussian beam profile 800 has a tapered profile with a varying diameter 815.

FIG. 9 shows a flow chart of a method 900 for producing an optical module according to an exemplary embodiment. The method comprises a step 905 of providing the solid body material, which in this exemplary embodiment is a glass substrate. The step 905 of providing is followed by a step 910 of inscribing the contour of the beam deflecting region into the solid body material. By way of example only, a laser direct writing method is used in this step 910, by means of which both the contour of the hollow mirror and that of the beam shaping element are inscribed in one manufacturing step. In another exemplary embodiment, the optical module can also be produced as part of an optical device, wherein in the step of inscribing, in addition to the contours of the optical module, the waveguide of the optical device can also be inscribed in the glass substrate. In this exemplary embodiment, following the step 910 of inscribing, in a step 915 of exposing, the beam shaping region of the optical module is exposed by selectively removing the solid body material. By way of example only, in this step 915 of exposing, the hollow mirror and the beam shaping element are shaped by selective etching and advantageously polished by a CO₂ laser.

FIG. 10 shows a block diagram of an exemplary embodiment of a control device for controlling a method for producing an optical module according to a variant presented here. The control device 100 comprises a providing unit 1005 for controlling a provision of a solid body material, an inscribing unit 1010 for controlling an inscription of the contour of the beam deflecting region into the solid body material and an exposing unit 1015 for controlling an exposing of the beam shaping region by selectively removing the solid body material described by the step of inscribing.

1. An optical device, comprising an optical module for modifying a light beam, wherein the optical module is made of a single-piece solid body material and comprises has the following features:
a passage surface for receiving the light beam;
a beam deflecting region lying opposite the passage surface for deflecting the light beam, wherein the beam deflecting region is designed as a curved region on the exterior of the optical module, in particular so as to have a hollow mirror function;
a pass-through surface for outputting the light beam deflected by the beam deflecting region; and
a beam shaping region which is designed to shape the light beam and/or the deflected light beam such that the light beam has a beam profile with a homogeneous intensity distribution over a specified range; and
a waveguide for guiding the light beam to the passage surface of the optical module, wherein the waveguide terminates at a distance from the beam deflecting region, in particular wherein the optical device is designed to allow the light to propagate divergently from one end of the waveguide to the beam deflecting region,
wherein the optical device and the optical module are made in a single piece from the solid body material.

2. An optical device, comprising an optical module for modifying a light beam, wherein the optical module is made of a single-piece solid body material and comprises:
a pass-through surface for receiving a light beam;
a passage surface for outputting the light beam deflected by the beam deflecting region;
a beam deflecting region lying opposite the passage surface for deflecting the light beam, wherein the beam deflecting region is designed as a curved region on the exterior of the optical module, in particular so as to have a hollow mirror function; and
a beam shaping region that is designed to shape the light beam such that the light beam has a beam profile with a homogeneous intensity distribution over a specified range; and
a waveguide for guiding the light beam from the passage surface of the optical module, wherein the waveguide terminates at a distance from the beam deflecting region, in particular wherein the optical device is designed to allow the light to propagate convergently from the beam deflecting region to one end of the waveguide,
wherein the optical device and the optical module are made in a single piece from the solid body material.

3. The optical device according to claim 1, wherein the beam deflecting region and the beam shaping region are arranged at overlapping sections of the exterior of the optical module.

4. The optical device according to claim 1, wherein the pass-through surface is formed by the beam shaping region.

5. The optical device according to claim 1, wherein the beam shaping region for shaping the light beam and/or the deflected light beam:
is either formed with at least two turning points; and/or
is formed free of turning points in the optical surface with at least two turning points in the first derivative of the optical surface.

6. The optical device according to claim 1, wherein the beam deflecting region is designed to convert the light beam into the deflected light beam by total internal reflection and/or is designed to deflect the light beam at an obtuse angle to obtain the deflected light beam.

7. The optical device according to claim 1, wherein the beam deflecting region is formed with a layer reflecting the light beam, in order to obtain the deflected light beam.

8. The optical device according to claim 1, wherein the light propagation in the optical device is free of free beam regions.

9. The optical device according to claim 1, wherein the beam deflecting region is formed as part of a blind hole in the solid body material.

10. The optical device according to claim 1, wherein the beam deflecting region for deflecting the light beam has a deflection angle between 70° and 120°, in particular between 95° and 110°.

11. An optical device according to claim 1, comprising at least two optical modules.

12. A method for producing an optical device, comprising
providing the solid body material;
inscribing the contour of the beam deflecting region into the solid body material;
exposing the beam shaping region in particular by selectively removing the solid body material described by the step of inscribing the contour of the beam deflecting region;
inscribing a waveguide into the solid body material, wherein the waveguide terminates at a distance from the beam deflecting region.
